(19) United States
(12) Patent Application Publication
(10) Pub. No.: US 2024/0336248 A1
(43) Pub. Date: Oct. 10, 2024

(54) VEHICLE DRIVE TRAIN OF A VEHICLE

(71) Applicant: Hoerbiger Antriebstechnik Holding GmbH, Schongau (DE)

(72) Inventors: Michael KOELZER, Schongau (DE); Markus SAUTER, Schongau (DE)

(21) Appl. No.: 18/625,636

(22) Filed: Apr. 3, 2024

(30) Foreign Application Priority Data
Apr. 5, 2023 (DE) 102023108791.6

(51) Int. Cl. B60W 10/02

(52) U.S. Cl. CPC B60W 10/02; B60W 2710/027

(57) ABSTRACT

The disclosure relates to a vehicle drive train of a vehicle comprising an engine which serves to drive at least one vehicle wheel, a multidisk brake assigned only to this driven vehicle wheel, and a clutch assigned only to this driven vehicle wheel, wherein the clutch is arranged between the engine and the vehicle wheel and, in the open state, decouples its associated vehicle wheel from the entire remaining vehicle drive train.

### TECHNICAL FIELD

The disclosure relates to a vehicle drive train of a vehicle.

### BACKGROUND

Particulate emissions from vehicle brakes occur during braking processes in which a brake lining is typically urged with pressure onto a brake disk or brake drum to cause a braking effect. This causes abrasion of the brake linings, resulting in particulate emissions, in particular fine dust emissions.

Microplastic emissions from tires are caused by tire abrasion, which is generated in every driving situation. However, abrasion is particularly high during acceleration and braking processes, as a particularly high force transmission occurs between the vehicle and the road pavement via the vehicle tire of the vehicle wheel.

The abrasion of vehicle tires and brake linings therefore results in wear. The greater the abrasion during vehicle operation, the sooner the worn parts need to be replaced.

As a result, emissions from both the brakes and the vehicle tires occur during braking processes.

It is the object of the disclosure to provide a vehicle drive train of a vehicle, wherein the term “vehicle drive train” shall also include the brakes, which allows low-emission or even emission-free operation of the vehicle with regard to the emissions of vehicle brakes and vehicle tires, in particular during braking processes. At the same time, the wear of brakes and tires is also to be minimized, so that the maintenance effort of the vehicle is reduced.

### SUMMARY

The disclosure provides a vehicle drive train of a vehicle comprising an engine which serves to drive at least one vehicle wheel, a multidisk brake assigned only to this driven vehicle wheel (i.e. not to another driven wheel), and a clutch assigned only to this driven vehicle wheel, wherein the clutch is arranged between the engine and the vehicle wheel and, in the open state, decouples its associated vehicle wheel from the entire remaining vehicle drive train.

The basic idea of the disclosure is, on the one hand, to reduce the rotating masses acting on the driven vehicle wheel, which act on the vehicle wheel through the remaining vehicle drive train, during driving operation, in particular when coasting, so that the entrained rotating masses are reduced. On the other hand, the rotating masses acting on the driven vehicle wheel through the remaining vehicle drive train are to be reduced in the event of a braking process by opening the clutch, so that the moment of inertia prevailing on the vehicle wheel during a braking process with the clutch open is lower than if the clutch were closed or no clutch were provided.

This ensures that the braking force required during a braking process with the clutch open is lower than with a closed clutch, as with an open clutch the braking force is only required to decelerate the vehicle and additionally only to decelerate the rotating masses of the vehicle drive train which are located between the clutch and the vehicle wheel, including the vehicle wheel itself.

Thus, during a braking process and with a clutch in the open state, a lower braking force is required to decelerate the vehicle than if the clutch were closed.

During a braking process, the moment of inertia acting on the vehicle wheel and which would usually be applied by the uncoupled part of the vehicle drive train is therefore reduced.

The lower braking force required can also result in reduced abrasion on the multidisk brake, such that the emission of fine dust particulates during the braking process is reduced.

In addition, (particulate) emissions from the brake are also reduced by the use of the multidisk brake itself, as it produces fewer emissions than conventional disk or drum brakes with the same braking force.

Overall, the multidisk brake in conjunction with the clutch assigned to one of the driven vehicle wheels can therefore lead to particularly low-emission braking processes.

The multidisk brake also has a considerable aerodynamic advantage over the current air-cooled disk or drum brakes, as they can be encapsulated on the outside and also run in oil, which leads to an effective hydraulic cooling. The vehicle drive train according to the disclosure may have such an encapsulated and/or oil-immersed multidisk brake.

The rim can thus also be closed on the outside, which has additional aerodynamic advantages.

For example, only one single clutch is provided for each driven vehicle axle, which is assigned only to this vehicle axle. If both vehicle axles are driven, each vehicle axle has its own single clutch. The clutch should be integrated into the drive train such that the two driven vehicle wheels of the same vehicle axle are decoupled from the remaining vehicle drive train using only one clutch.

If several drive axles are driven, the concept of how both wheels of the same drive axle are decoupled from the drive using only one clutch may also be different. Various of these concepts are presented below.

One aspect provides that the vehicle wheel, together with the multidisk brake and that part of the vehicle drive train which is located between the vehicle wheel and the clutch, is decoupled from the entire remaining vehicle drive train when the clutch is open.

This therefore enables the vehicle wheel to continue to be decelerated via the multidisk brake even when the clutch is open, and still ensures that only the moments of inertia of the rotating masses between the vehicle wheel and the clutch, including the vehicle wheel itself and part of the clutch, act during a braking process and not those of the entire vehicle drive train.

The clutch may be arranged in the multidisk brake between a transmission assigned only to this vehicle wheel or only to one vehicle axle.

In accordance with the above explanations, this therefore allows the vehicle wheel to be decelerated by means of the multidisk brake even when the clutch is open and simultaneously decoupled from the transmission, so that the moment of inertia of the transmission caused by the rotating masses does not act on the vehicle wheel during a braking process.

Alternatively, the clutch may be arranged directly between the vehicle wheel and the multidisk brake.

This results in a maximum reduction of the rotating masses on the vehicle wheel, as the latter can be decoupled from the entire remaining vehicle train, including the multidisk brake.

This allows the wheel to rotate freely, for example when the vehicle is coasting, without any undesirable braking force acting on the vehicle wheel due to a slipping of the brake. However, if the vehicle is to be accelerated or decelerated via the driven vehicle wheel, the clutch must be closed immediately so that braking or driving forces can be transmitted to the driven vehicle wheel. In this variant, the moments of inertia caused by the vehicle drive train therefore act on the vehicle wheel during a braking process.

Furthermore, it is also conceivable that the clutch is arranged directly between the engine and the multidisk brake without the interposition of a transmission.

In this embodiment, the engine could, for example, drive the vehicle wheel via a drive shaft when the clutch is closed and, when the clutch is opened, be separated from the vehicle wheel along with the multidisk brake so that a deceleration of the vehicle wheel is also possible when the clutch is open.

In the case of an electric motor, it should be noted that in the event of deceleration only by recuperation when the battery is fully charged, a secondary consumer of electrical power must be available to dissipate the electrical power generated.

Alternatively, it would also be conceivable for the engine to act as a wheel hub drive, so that a braking force via the multidisk brake on the vehicle wheel is only possible when the clutch is closed and the moment of inertia of the engine would act on the vehicle wheel during a braking process.

The clutch may also be provided between the transmission and a cardan shaft. In this arrangement, opening the clutch results in an entire vehicle axle along with the transmission being decoupled from the remaining vehicle drive train.

It is furthermore possible to provide the clutch between the transmission and a drive shaft of the driven vehicle wheel. In this way, the clutch can be provided at the transmission output towards the drive shaft, which permits a particularly easy integration of the latter.

Alternatively, the clutch may also be provided in the transmission. This also enables the clutch to be accommodated in a simple and space-saving manner.

Furthermore, it is also conceivable that the clutch is provided on a drive shaft of the driven vehicle wheel. This has the advantage that part of the moments of inertia of the vehicle drive train caused by the rotating masses can be decoupled from the vehicle wheel along with the multidisk brake and part of the drive shaft when the clutch is open.

Furthermore, the clutch may also be provided in a wheel hub of the driven vehicle wheel. This enables space-saving accommodation and also has the advantage that part of the rotating mass of the vehicle drive train no longer acts on the driven vehicle wheel during a braking process when the clutch is open.

Optionally, the clutch is provided on or in the transmission, and the vehicle wheel with the multidisk brake and the part of the vehicle drive train from the vehicle wheel to the transmission or part of the transmission is decoupled from the entire remaining vehicle drive train when the clutch is open, the transmission being in particular a transfer case and/or a differential transmission.

For example, two driven vehicle wheels of a vehicle axle can be decoupled from the remaining vehicle drive train by means of a single clutch. This can be realized, for example, by positioning the clutch at the transfer case output or at the differential transmission input.

Furthermore, the clutch may also be positioned at the differential output, i.e. at the differential output shaft towards a driven vehicle wheel, so that opening results in direct uncoupling of the one driven vehicle wheel.

Advantageously, the vehicle wheel is assigned to a vehicle axle which comprises a differential wheel and a second driven vehicle wheel having a second multidisk brake assigned only to the second vehicle wheel and, when the clutch is open, the differential spins and a force transmission can take place between the engine and the second vehicle wheel.

In this way, two driven vehicle wheels can be decoupled from the remaining vehicle drive train using only one clutch.

The clutch may be a slipping clutch and/or a positive clutch. A positive clutch is a clutch with form-fitting geometries which engage with each other so that the torque is transferred via such positive, i.e. in a form-fitting manner engaging parts with their specific geometries.

Advantageously, the clutch is a positive clutch, a slipping clutch being integrated into the positive clutch, which slips when a defined torque is exceeded.

The slipping clutch thus acts as overload protection. This is the case, for example, in highly dynamic processes, such as when accelerating the vehicle, where high torques are applied, the maximum transmittable torque is limited to prevent force peaks in the vehicle drive train which could lead to possible damage or excessive wear.

In addition, the slipping clutch may also limit the maximum transmittable torque if torques act in the drive train which are caused by changing traction conditions due to suddenly changing friction values (e.g. ice on dry roads) during active drive.

Furthermore, an actuator may be assigned to the clutch which serves to open and/or close the clutch and actuates the clutch hydraulically, pneumatically, electromechanically or electromagnetically.

Hydraulic actuation allows particularly high switching forces of the actuator. Pneumatic actuation is particularly suitable if the vehicle is anyway equipped with a compressed-air system or a vacuum system. Electromechanical actuation enables particularly precise adjustment of the clutch. Electromagnetic actuation allows the clutch to be opened and closed particularly quickly.

Advantageously, a control means is provided which is set up to activate the actuator and controls the actuator depending on the driving state of the vehicle to cause an automatic opening and closing of the clutch. A manual switching of the clutch is therefore not necessary. Rather, the control means is based on the driving state of the vehicle. Driving states may be, for example, braking processes, acceleration processes and/or coasting of the vehicle.

Optionally, the control means is programmed so as to cause an opening of the clutch during a braking process, in particular during a braking process in which there is no recuperation. The control means can further be programmed such that an opening of the clutch is also caused when the vehicle is coasting.

In accordance with the above explanations, due to the decoupling of the vehicle wheel from the entire remaining vehicle drive train during a braking process in which there is no recuperation, only lower braking forces are to be applied, thus reducing the emissions caused by the multidisk brake.

If recuperation takes place during the braking process anyway, so that the actual braking force is applied by an electric motor, it is not necessary to decouple the driven vehicle wheel. During recuperation, the braking force is applied solely or practically solely by the electric motor in the generator mode, so that the multidisk brake is only actuated slightly, if at all, and the resulting emissions are negligibly low.

When the vehicle is coasting, the driven vehicle wheel can be decoupled so that no resistance, caused for example by friction in the vehicle drive train, acts on the drive wheel of the vehicle during coasting and decelerates the latter without this being desired.

The multidisk brake may have an encapsulated multidisk brake housing and inner disks and outer disks which are accommodated in encapsulated multidisk brake housings.

The actual braking force of a multidisk brake is generated by applying the inner and outer disks to each other, which generates friction and therefore abrasion as explained above. As the inner and outer disks are accommodated in the encapsulated multidisk brake housing, this abrasion is collected within the multidisk brake housing, and there are no emissions to the environment. Due to this design, emission-free braking processes can be realized in relation to the brake.

### BRIEF DESCRIPTION OF THE DRAWINGS

FIG. 1 shows a schematic representation of a vehicle equipped with a vehicle drive train according to the disclosure in a plan view in accordance with a first option;

FIG. 2a shows a schematic representation of a vehicle drive train according to the disclosure in accordance with the first option with a clutch in the open state;

FIG. 2b shows a schematic representation of the vehicle drive train according to the disclosure in accordance with the first option with the clutch in the closed state;

FIG. 3 shows a schematic representation of the vehicle equipped with a vehicle drive train according to the disclosure in a plan view in accordance with a second option;

FIG. 4a shows a schematic representation of a vehicle drive train according to the disclosure in accordance with the second option with a clutch in the open state;

FIG. 4b shows a schematic representation of the vehicle drive train according to the disclosure in accordance with the second option with the clutch in the closed state;

FIG. 5 shows a schematic representation of a vehicle equipped with a vehicle drive train according to the disclosure in a plan view in accordance with a third option;

FIG. 6a shows a schematic representation of the vehicle drive train according to the disclosure in accordance with the third option with a clutch in the open state;

FIG. 6b shows a schematic representation of the vehicle drive train according to the disclosure in accordance with the third option with the clutch in the closed state;

FIG. 7 shows a schematic representation of a vehicle equipped with a vehicle drive train according to the disclosure in a plan view in accordance with a fourth option;

FIG. 8a shows a schematic representation of the vehicle drive train according to the disclosure in accordance with the fourth option with a clutch in the open state; and

FIG. 8b shows a schematic representation of the vehicle drive train according to the disclosure in accordance with the fourth option with the clutch in the closed state.

### DETAILED DESCRIPTION

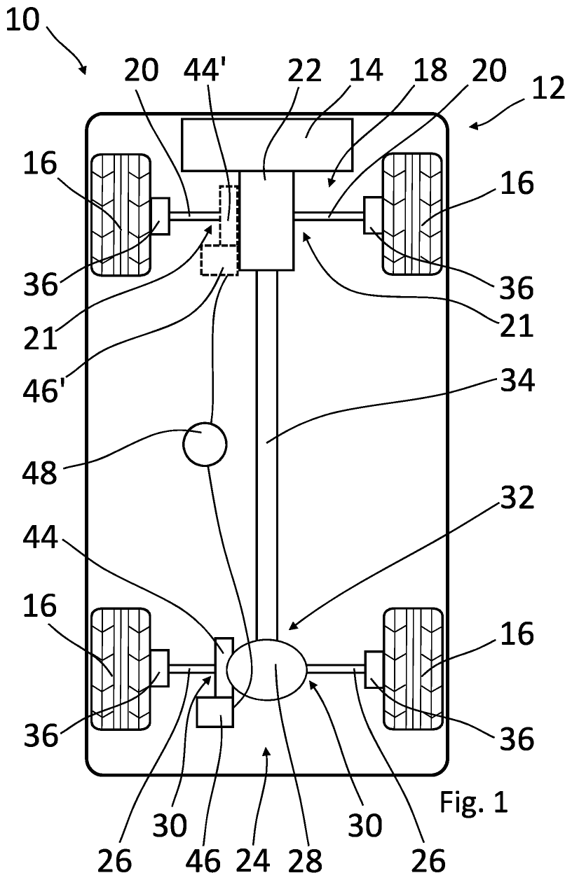

FIG. 1 shows a vehicle 10 having a vehicle drive train 12 according to a first option.

The vehicle drive train 12 comprises at least one engine 14 which serves to drive a vehicle wheel 16. According to FIG. 1, all four vehicle wheels 16 can also be driven by the engine. The engine can be an electric motor, an internal combustion engine or a hybrid drive engine.

The vehicle drive train 12 has a front axle 18, the driven vehicle wheels 16 of which are coupled to the engine 14 via drive shafts 20 connected to transmission outputs 21 of a transmission 22 arranged on the engine 14.

In addition, the vehicle drive train 12 according to FIG. 1 has a rear axle 24, the driven vehicle wheels 16 of which are coupled via drive shafts 26 to a transmission 28 designed as a differential, drive shafts 26 being connected to transmission outputs 30 of the transmission 28.

The transmission 28 also has a transmission input 32, which in turn is coupled to the transmission 22 arranged on the engine via a cardan shaft 34.

FIG. 1 shows only one possible configuration. It is basically also conceivable that only the front axle 18 or only the rear axle 24 comprises vehicle wheels 16 driven by the engine 14. Consequently, depending on the configuration, the one or other components of the vehicle drive train 12 described above are not absolutely necessary.

Furthermore, the vehicle drive train 12 comprises multidisk brakes 36, each of which is assigned to only one single driven vehicle wheel 16.

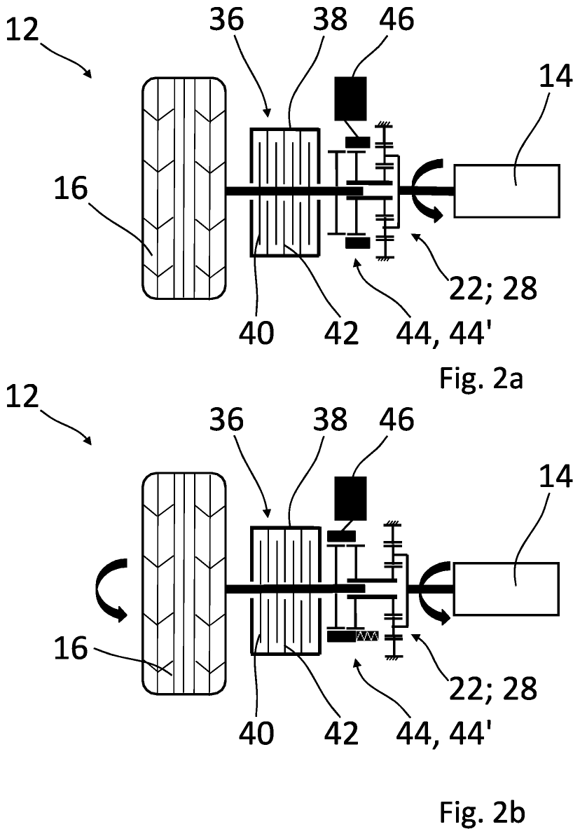

The multidisk brakes 36 each have a multidisk brake housing 38 and inner disks 40 and outer disks 42. The inner disks 40 and the outer disks 42 are accommodated in the encapsulated multidisk brake housing 38 (see FIG. 2). Furthermore, each multidisk brake 36 can be actuated hydraulically, pneumatically, electromechanically or electromagnetically to generate a braking force.

The multidisk brakes 36 are cooled by oil, for example.

Due to the encapsulated multidisk brake housing 38, abrasion, in particular abrasion in the form of particulates and fine dust from the inner disks 40 and/or the outer disks 42, remains inside the multidisk brake housing 38 when the multidisk brake 36 is actuated.

In addition, the vehicle drive train 12 comprises at least one clutch 44 respectively assigned to only one single driven vehicle wheel 16.

The clutch 44 can be a frictionally engaged clutch and/or a positive clutch.

If the clutch 44 is designed as a positive clutch, it is conceivable that a slipping clutch is integrated into the positive clutch, which slips when a defined torque is exceeded to prevent load peaks in the vehicle drive train 12.

An actuator 46 is provided to open and close the clutch 44 (see in particular FIGS. 2a, 2b). The clutch 44 can be actuated hydraulically, pneumatically, electromechanically or electromagnetically via the actuator 46.

In addition, a control means 48 is provided, which is coupled to the actuator 46 or 46′ and is set up to activate the actuator 46. The activation takes place as a function of the driving state of the vehicle to cause an automatic opening and closing of the clutch 44, 44′ by means of the actuator 46.

In FIG. 1, this clutch 44 is assigned to the driven left-hand vehicle wheel 16 of the rear axle 24. It is arranged between the engine 14 and the relevant driven vehicle wheel 16, so that in the open state, the clutch 44 decouples the associated driven vehicle wheel 16 from the remaining vehicle drive train 16.

Alternatively or additionally, such clutches 44 may also be assigned to each or only individual ones of the other driven vehicle wheels 16.

To illustrate this, a further clutch 44′ is indicated in FIG. 1 by the dashed line, which is assigned to the driven left-hand vehicle wheel 16 of the front axle 18 as an example.

The interposition of the clutch 44 or 44′ is shown schematically in FIGS. 2a and 2b.

FIG. 2a shows the clutch 44 or 44′ in the open state. It is apparent therefrom that opening the clutch 44 or 44′ results in the driven vehicle wheel 16, along with the multidisk brake 36 and the output-side part of the clutch 44 itself, being decoupled from the entire remaining vehicle drive train, i.e. in particular the transmission(s), which here can be the transmission 22 arranged on the engine and/or the transmission 28, and from the other components of the vehicle drive train 12, including the engine 14.

Closing the clutch 44 as shown in FIG. 2b in turn results in the driven vehicle wheel 16 and the multidisk brake 36 being coupled to the remaining part of the vehicle drive train. This is indicated by the additional arrow on the driven vehicle wheel 16 in FIG. 2b.

According to the first option, the clutch 44 or 44′ is thus arranged, generally speaking, between a transmission assigned only to the driven vehicle wheel 16 and a transmission assigned to a vehicle axle 18, 24, which in this case may be the transmission 22 or 28 arranged on the engine 14, and a multidisk brake 36 arranged on the vehicle wheel 16.

The exact positioning of the clutch 44 or 44′ can be selected differently.

It is thus conceivable to provide the clutch 44 or 44′ between the transmission 28 and the drive shaft 26 or between the transmission 22 arranged on the engine 14 and the drive shaft 20 of the respective driven vehicle wheel 16.

The clutch 44 or 44′ itself can be provided directly at the respective transmission output 21 or 30 on the outside of the respective transmission 22 or 28 or can be provided in the transmission 22 or 28, i.e. the housing. Thus, when the clutch 44 or 44′ is open, the respective driven vehicle wheel with the part of the vehicle drive train from the vehicle wheel itself to the transmission 22 or 28 is decoupled from the entire remaining vehicle drive train.

Alternatively, it is also conceivable that the clutch is provided on the drive shaft 20 or 26 of the respective driven vehicle wheel 16.

Furthermore, it is also conceivable to provide the clutch 44 or 44′ in the wheel hub of the respective driven vehicle wheel 16 (not shown in FIG. 1), so that when the clutch 44 or 44′ is open, the vehicle wheel 16 along with the multidisk brake 36 is already decoupled from the remaining vehicle drive train from the drive shaft 20 or 26.

If a setup according to FIG. 1 is selected, in which only one single clutch 44 or 44′ is arranged on the front axle 18 and/or on the rear axle 24 and the drive shafts 20 or the drive shafts 26 are connected to the transmission outputs 21 or 30 of a transmission designed as a differential, it is possible for the driven vehicle wheel 16 to be decoupled from the entire remaining vehicle drive train when the clutch 44 or 44′ is open and that the transmission 22 or 28 designed as a differential spins and no force transmission can take place between the engine 14 and the respective second vehicle wheel 16 on the front axle 18 and/or on the rear axle 24.

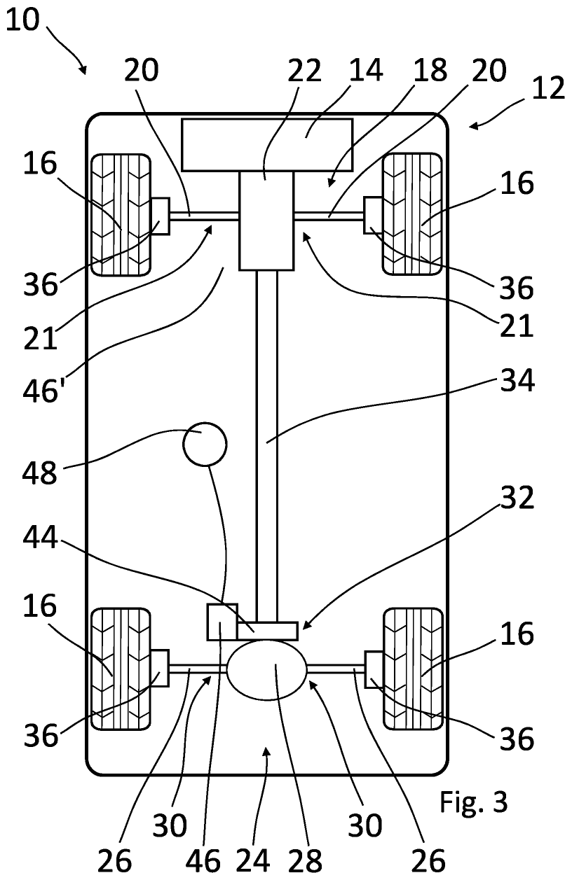

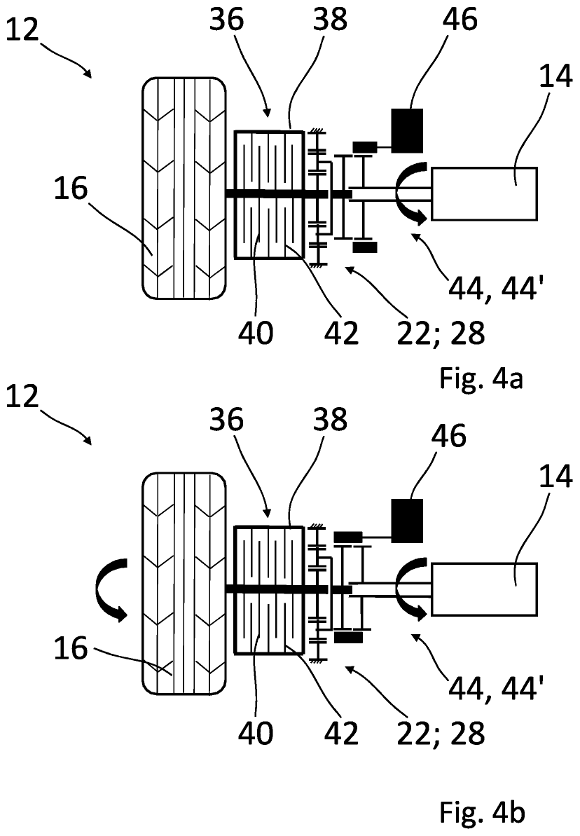

FIGS. 3 to 4b show a vehicle drive train 12 according to a second option. In contrast to the previous option, the clutch 44 of the second option is positioned between the transmission 28 and the cardan shaft 34. The explanations given above for the first option can generally be applied analogously to the second option.

Accordingly, as also shown in FIG. 4a, when the clutch 44 is open, the vehicle wheel 16 with the multidisk brake 36 and the part of the vehicle drive train 12 from the vehicle wheel 16 to the transmission 28 or to at least part of the transmission 28 would be decoupled from the remaining vehicle drive train when the clutch is open.

The decoupling of the driven vehicle wheels 16 on the rear axle 24 from each other is effected by the transmission 28, which is designed as a differential and which spins in case of a relative speed difference between the driven vehicle wheels 16.

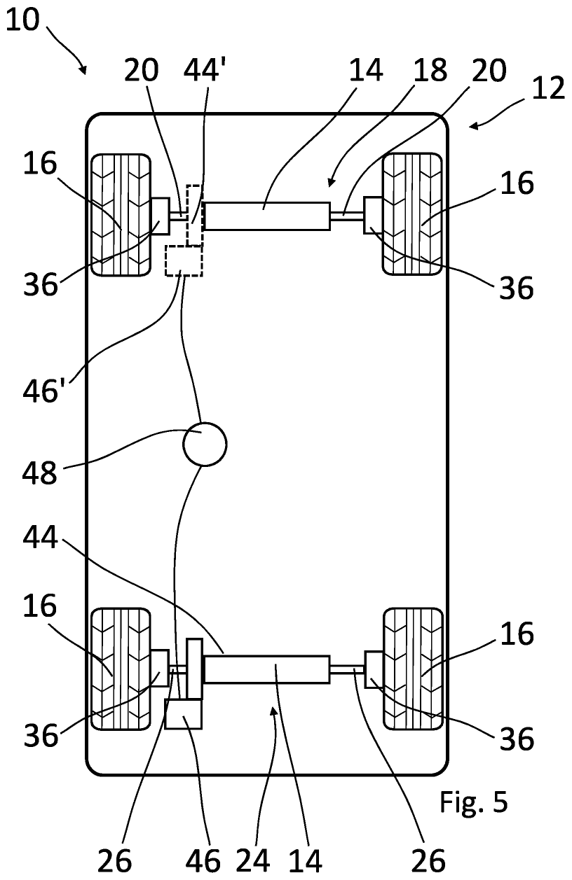

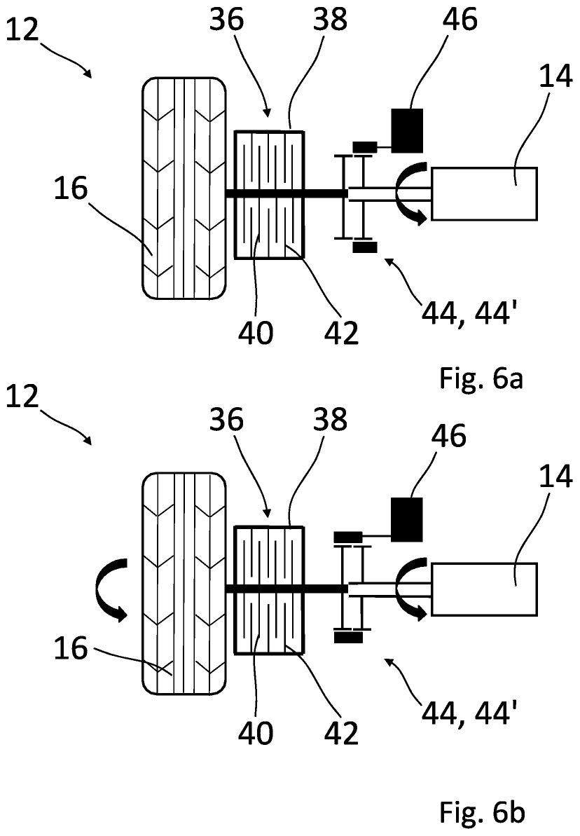

FIGS. 5 to 6b show a vehicle drive train 12 according to a third option. Here, both the front axle 18 and the rear axle 24 each have an engine 14 and thus also driven vehicle wheels 16. However, it is also conceivable that only one of the vehicle axles 18, 24 comprises driven vehicle wheels 16. As already mentioned for option 2, the explanations given above for the first option can generally be applied analogously to the second option.

In this third option, the clutch 44 or 44′ is arranged directly between the engine 14 and the multidisk brake 36 of the respective driven vehicle wheel 16 without the interposition of a transmission.

In FIG. 5, only one clutch is arranged on the front axle 18 and on the rear axle 24, each of which is assigned to only one driven vehicle wheel 16 of the vehicle axles 18, 24.

However, it is also possible that a clutch 44 or 44′ is assigned to both driven vehicle wheels 16 of the front axle 18 or rear axle 24.

According to FIG. 6a, when the clutch 44 is open, the driven vehicle wheel 16, along with the associated multidisk brake 36 and a part of the clutch 44 itself, is decoupled from the entire remaining vehicle drive train, which consists in particular of the drive shafts 20 or 26 and the engine 14.

The operation of the clutch 44 and/or 44′ of the first to third options will be explained below.

In accordance with the above explanations, the control means 48 is intended to activate the actuator 46 on the basis of the driving state and to cause an automatic opening and closing of the clutch 44 and/or 44′.

To this end, the control means 48 is programmed so as to cause an opening of the clutch 44 and/or 44′ during a braking process, so that the respective driven vehicle wheel 16 to which the clutch 44 and/or 44′ is assigned is decoupled from the entire remaining vehicle drive train with the multidisk brake 36 and the part of the vehicle drive train from the respective driven vehicle wheel 16 up to the open clutch. As a result, the moments of inertia acting through the rotating masses do not act during the braking process, so that the braking force which must be applied by the multidisk brake 36 can be lower than if the clutch 44 and/or 44′ were closed.

If recuperation takes place during the braking process in electric vehicles, for example, or if the engine is used as an engine brake in a vehicle having an internal combustion engine, it is also conceivable that the control means 48 does not open the clutch 44 and/or 44′ as long as recuperation or braking by the engine takes place.

Furthermore, the control means 48 can also be programmed so as to cause the clutch 44 and/or 44′ to open when the vehicle 10 is coasting, so that any losses, for example due to friction in the vehicle drive train 12, do not affect the respective driven vehicle wheel 16.

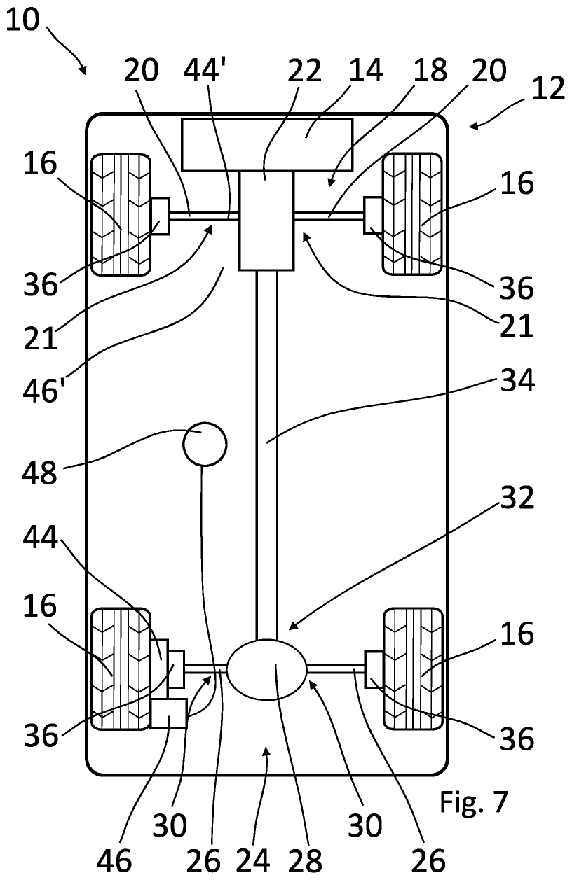

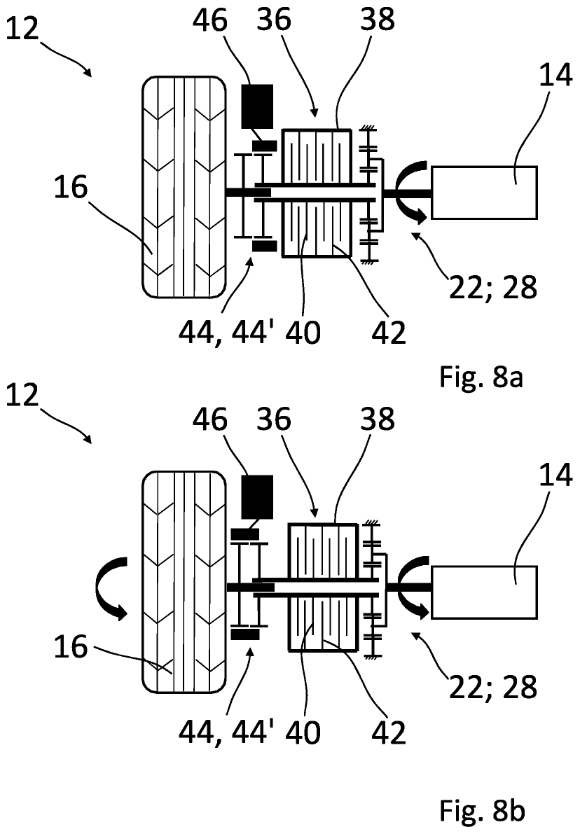

In addition to the previously discussed options 1 to 3, which are shown in FIGS. 1 to 6b, the vehicle drive train 12 according to the fourth option, which is shown in FIGS. 7 to 8b, is explained below.

In contrast to all previous options, the clutch 44 in the fourth option is provided directly on the driven vehicle wheel 16, so that opening the clutch 44 results in a decoupling of the vehicle wheel 16 from the entire vehicle drive train, including the multidisk brake 36.

Apart from this, the explanations given above for the first option apply to the exclusion of the operation of the clutch.

In contrast to the previous options, in the vehicle drive train 12 according to the fourth option, the clutch 44 must be closed during a braking process, so that the driven vehicle wheel 16 is coupled to the associated multidisk brake 36 and a braking force can be transmitted from the multidisk brake 36 to the driven vehicle wheel 16.

Accordingly, in the fourth option, the control means 48 must activate the actuator 46 if the clutch 44 is in the open state and a braking process is to be initiated.

This process must take place extremely quickly so that there is no time delay when a braking process is to be initiated.

Automatic opening by activating the actuator 46 via the control means 48 could then take place if the vehicle is in a coasting mode and the driven vehicle wheel 16 is not to be braked by resistance, such as friction in the vehicle drive train 12.

In the embodiments shown, at least one driven vehicle axle is provided and one single, separate clutch is provided for each driven vehicle axle, which is inserted into the drive train such that it can be used to decouple all driven wheels of this vehicle axle from the drive. This is possible, for example, by arranging the clutch upstream of the differential or downstream of the differential and in a partial train between the differential and one of the two drive wheels.

1. A vehicle drive train of a vehicle comprising an engine which serves to drive at least one vehicle wheel, a multidisk brake assigned only to this driven vehicle wheel, and a clutch assigned only to this driven vehicle wheel,
wherein the clutch is arranged between the engine and the vehicle wheel and, in the open state, decouples its associated vehicle wheel from the entire remaining vehicle drive train.

2. The vehicle drive train according to claim 1, wherein the vehicle wheel, together with the multidisk brake and with that part of the vehicle drive train which is located between the vehicle wheel and the clutch, is decoupled from the entire remaining vehicle drive train when the clutch is open.

3. The vehicle drive train according to claim 1, wherein at least one driven vehicle axle is provided and a single, separate clutch is provided for each driven vehicle axle.

4. The vehicle drive train according to claim 1, wherein the clutch is arranged between a transmission assigned only to this vehicle wheel or only to one vehicle axle and the multidisk brake, directly between the vehicle wheel and the multidisk brake, or directly between the engine and the multidisk brake without the interposition of a transmission.

5. The vehicle drive train according to claim 1, wherein the clutch is provided between the transmission and a cardan shaft, or between the transmission and a drive shaft of the driven vehicle wheel, or in the transmission, or on a drive shaft of the driven vehicle wheel, or in a wheel hub of the driven vehicle wheel.

6. The vehicle drive train according to claim 1, wherein the clutch is provided on or in the transmission and the vehicle wheel with the multidisk brake and the part of the vehicle drive train from the vehicle wheel to the transmission or a part of a transmission is decoupled from the entire remaining vehicle drive train when the clutch is open.

7. The vehicle drive train according to claim 1, wherein the vehicle wheel is assigned to a vehicle axle which comprises a differential and a second driven vehicle wheel having a second multidisk brake assigned only to the second vehicle wheel, and wherein the differential spins and no force transmission can take place between the engine and the second vehicle wheel when the clutch is open.

8. The vehicle drive train according to claim 1, wherein the clutch is a frictionally engaged and/or a positive clutch.

9. The vehicle drive train according to claim 1, wherein the clutch is a positive clutch, a slipping clutch which slips when a defined torque is exceeded being integrated into the positive clutch.

10. The vehicle drive train according to claim 1, wherein an actuator is assigned to the clutch which serves to open and/or close the clutch and actuates the clutch hydraulically, pneumatically, electromechanically or electromagnetically.

11. The vehicle drive train according to claim 10, wherein a control means is provided which is set up to activate the actuator and controls the actuator depending on the driving state of the vehicle to cause an automatic opening and closing of the clutch.

12. The vehicle drive train according to claim 11, wherein the control means is programmed so as to cause an opening of the clutch during a braking process.

13. The vehicle drive train according to claim 12, wherein the control means is programmed so as to cause an opening of the clutch during a braking process in which there is no recuperation and/or during coasting of the vehicle.

14. The vehicle drive train according to claim 1, wherein the multidisk brake has an encapsulated multidisk brake housing, inner disks and outer disks which are accommodated in the encapsulated multidisk brake housing.

15. The vehicle drive train according to claim 14, wherein the multidisk brake is cooled by oil.
